(19) United States
(12) Patent Application Publication
(10) Pub. No.: US 2014/0110636 A1
(43) Pub. Date: Apr. 24, 2014

(54) TEMPLATE-FREE AQUEOUS SYNTHESIS OF CONDUCTIVE POLYMER NANOPARTICLES

(71) Applicants: Christopher A. Vetter, Fargo, ND (US); Victoria J. Gelling, Fargo, ND (US)

(72) Inventors: Christopher A. Vetter, Fargo, ND (US); Victoria J. Gelling, Fargo, ND (US)

(73) Assignee: NDSU RESEARCH FOUNDATION, Fargo, ND (US)

(21) Appl. No.: 14/124,537

(22) PCT Filed: Jun. 7, 2012
(86) PCT No.: PCT/US12/41270

§ 371 Date: Dec. 6, 2013

Related U.S. Application Data
(60) Provisional application No. 61/520,282, filed on Jun. 7, 2011.

(51) Int. Cl. H01B 1/12; H01B 1/02

(52) U.S. Cl. CPC H01B 1/128; H01B 1/127; H01B 1/02
USPC 252/514; 526/258; 526/75; 526/235; 526/210; 526/212; 528/422; 252/500

(57) ABSTRACT

A method of synthesizing conductive polymer nanoparticles is provided. In addition, stabilized conductive polymer nanoparticles are provided as are stabilized nanoparticles.

### CROSS-REFERENCE TO RELATED APPLICATIONS

This application claims the benefit of U.S. Application Ser. No. 61/520,282 filed Jun. 7, 2011, which is incorporated by reference herein.

### STATEMENT REGARDING FEDERALLY SPONSORED RESEARCH

This invention was made with government support from Army Research Laboratory grants W911 NF-09-2-014, W911 NF-10-2-0082, and W911 NF-11-2-0027. The government has certain rights in this invention.

### BACKGROUND

Because of their unique properties, there is currently great interest in conductive polymer nanoparticles for use in a variety of applications, including chemical and biological sensors, optically transparent conductive materials, electrochemical devices, actuators, supercapacitors, photovoltaic cells, transistors, data storage and surface protection. One of the major obstacles associate with the synthesis of conductive polymer nanoparticles is their unstable nature, which is traditionally overcome through the use of soft or hard templates. Such methods use expensive surfactants, often in large amounts, and require the removal of the template, which adds complexity, expense and environmental hazard. As a result, there is interest in developing alternative ways to synthesize conductive nanoparticles.

### SUMMARY

In one embodiment, the invention provides a template-free method of synthesizing conductive polymer nanoparticles comprising contacting a conductive monomer with an oxidant in an aqueous solvent to form conjugated polymer nanoparticles.

In another embodiment, the invention provides a template-free method of synthesizing conductive polymer nanoparticles consisting essentially of contacting a conductive monomer with an oxidant in an aqueous solvent.

In a further embodiment, the invention provides a method of producing a stabilized nanoparticle comprising contacting a conductive monomer with an oxidant in an aqueous solvent to form a reaction mixture; removing excess oxidant from the reaction mixture; and adding a particle to the reaction mixture to form a stabilized nanoparticle; wherein the stabilized nanoparticle has a coating of conductive polymer nanoparticles.

In yet another embodiment, the present invention provides a stabilized conductive polymer nanoparticle wherein the nanoparticle is not stabilized sterically or electrostatically.

Additionally, the present invention provides a conductive polymer nanoparticle with a zeta potential measurement of about zero.

In another embodiment, the present invention provides a stabilized nanoparticle comprising a conductive polymer shell around the nanoparticle.

Other aspects of the invention will become apparent by consideration of the detailed description and accompanying drawings.

### BRIEF DESCRIPTION OF THE DRAWINGS

FIG. 1 is a graph showing the number-weighted particle size distribution for the product of reaction A.

FIG. 2 is a graph of the number-weighted particle size distribution for the product of reaction B.

FIG. 3 is a graph of the number-weighted particle size distribution for the product of reaction C.

FIG. 4 is a graph of the number-weighted particle size distribution for the product of reaction D.

FIG. 5 shows transmission electron microscopy (“TEM”) images of the particles produced from reaction A (a and b) and reaction B (c and d).

FIG. 6 is a plot of the isothermal TGA data collected from reactions R-1 through R-3.

FIG. 7 shows TEM images of the particles produced from reactions R-13 (a), R-4 (b), R-9 (c), R-14 (d), and R-10 (e and f).

FIG. 8 is a graph of molar concentration vs. mean particle diameter for reactions R-1 through R-15.

FIG. 9 shows FTIR spectra showing the effect of increased reaction time and reduced pH for reactions R-24, R-34, and R-36.

FIG. 10 shows high resolution SEM images of the nanoparticles produced from reaction R-3 (Left) and reaction R-4 (Right).

FIG. 11 shows C-AFM images collected from a pressed pellet of the polypyrrole nanoparticles.

FIG. 12 shows UV-Vis spectroscopy of reactions R-17 and R-24 (pH of 4 and 1.6 respectively).

FIG. 13 shows UV-Vis spectra results at increased reaction time, and reduced pH. (R-33 to R-36).

FIG. 14 shows SEM images of polyaniline nanospheres (A and B); SEM images of polyaniline nanospheres (1 and 2).

FIG. 15 shows FTIR spectroscopy of PANI and PPY nanospheres.

FIG. 16 shows FTIR spectroscopy of PANI and PPY nanospheres.

FIG. 17 shows the relationship between reaction temperature and particle size.

FIGS. 18A & 18B shows Transmission Electron Microscopy (TEM) of R-6 (Example 7). Note: Scale bar of FIG. 18A represents 200 nm. Scale bar of FIG. 18B represents 50 nm.

FIGS. 19A & 19B shows Transmission Electron Microscopy (TEM) of R-2 (Example 7). Note: Scale bars of both the images represent 100 nm.

### DETAILED DESCRIPTION

There is currently significant interest in electroactive conductive polymers (ECPs), such as polypyrrole, for use in various applications such as chemical and biological sensors, optically transparent conductive materials, electrochromic devices, actuators, supercapacitors, photovoltaic cells, transistors, data storage, and surface protection. The primary reason for the interest in ECPs is their redox active behavior. Typically, the polymer is conductive in the oxidized form whereby anions (A), often referred to as dopants, are incorporated to maintain charge neutrality. Upon the addition of electrons, the polymer is reduced, causing the release of the anion. There are two main forms of oxidation utilized to synthesize ECPs: electrochemical oxidation via the application of an oxidizing potential and chemical oxidation via the introduction of a chemical oxidant. The resulting conductivity of the ECP depends upon the method of oxidation, the oxidant (in the case of chemical oxidation), the dopant, and the structure of the conjugated polymer.

Beyond the numerous applications of bulk ECPs, nanoparticles of ECPs have potentially enhanced properties, making them of interest to the scientific community. Conductive nanoparticles have many potential applications due to the changes in color that appear during redox cycling, their conductivity, and responsive properties. There have been reports that ECPs achieve higher conductivity when their structures are more highly ordered. Moreover, there are many reports in the literature of the unique optical and conductive properties observed by nanoparticles, such as gold quantum dots, and, correspondingly there is interest in similar optical studies of ECP nanoparticles. Finally, the high surface area to volume ratio of the ECP nanoparticles would be of interest to drug release and corrosion inhibition studies.

Due to their potential applications, a variety of methods have been attempted to synthesize such conductive polymer nanoparticles, with varying levels of success. Two main strategies, hard and soft template processes, have emerged to synthesize non-aggregated conductive polymer nanoparticles (CPN). Hard template processes use pores in “hard” materials, such as anodized aluminum oxide, to direct the growth of CPN and wires. After the synthesis, the templates must then be etched away, which is usually done with strong acids. Another variation of the hard template approach is the coating of colloidal particles, such as silver or silica, with polypyrrole. Some disadvantages of hard template processes are the high expense and complexity of the synthesis procedure, which involves the very carefully controlled growth of oxide layers or colloidal particles to give precise and uniform pore sizes or particle sizes. Soft template methods typically use surfactant micelles as a template for the formation of nanoparticles. Microemulsion polymerization and reversed-microemulsion polymerization are examples of soft template based methods, wherein the structure and concentration of the surfactant and monomers are critical factors for controlling the morphological parameters of products. Soft template processes typically generate products from which the soft template can never be fully removed, which will influence the properties of the final product. In addition, the process can be quite expensive due to the large amount of surfactant that is typically required.

Another challenge when synthesizing nanoparticles is to prevent agglomeration. Agglomeration is more pronounced with nanosized particles due to the increased surface area, which results in greater van der Waals interactions. The two widely accepted mechanisms for stabilization of conductive polymeric particles are steric stabilization and electrostatic stabilization. In steric stabilization, adsorbed or chemically grafted polymeric chains provide steric hindrance to coagulation of particles in order to provide stability. Steric stabilization is an entropically driven phenomenon that results from relaxed polymer chains on the outer surface of a particle. When the polymer chains on the surface of a particle are placed into a medium for which they have an affinity, a relaxed conformation occurs, which represents the highest entropic state for the polymer. Aggregation would require the surrounding chains to change to a less relaxed conformation, resulting in a decrease in entropy. Therefore, in a sterically stabilized dispersion, agglomeration is entropically unfavorable. Polyvinyl alcohol (PVA) is a common steric stabilizer reported in the literature. In electrostatic stabilization, like charges distributed on the surface of particles provide ample repulsion to maintain a sufficient distance between particles to prevent agglomeration. Electrostatic stabilization in silica-conductive polymeric nanocomposites is well reported in the literature.

Among other things, the invention provides a method of producing conductive polymer nanoparticles. The method of the present invention is a simple one-pot synthesis which is environmentally friendly. In one aspect, the method comprises contacting a conductive monomer with an oxidant in an aqueous solvent to form conjugated polymer nanoparticles. In one embodiment, the monomer is dissolved in the aqueous solvent and the oxidant is added thereto. Alternatively, the oxidant is dissolved in the aqueous solvent and the monomer is added thereto. The present invention also provides a method of producing conductive polymer nanoparticles consisting essentially of contacting a conductive monomer with an oxidant in an aqueous solvent to form conjugated nanoparticles. In one embodiment, the present invention provides a method for synthesis of a conductive polymer nanoparticle that is template-free.

In certain embodiments, the monomer is exposed to the oxidant for about 30 seconds to about 60 seconds. In other embodiments, the monomer is exposed to the oxidant for at least 30 seconds. In other embodiments, the monomer is exposed to the oxidant for no more than 120 seconds. In other embodiments, the monomer is exposed to the oxidant for about 30 seconds to about 120 seconds or about 60 seconds to about 120 seconds.

As used herein, a “conductive monomer” is monomer that forms a conductive polymer when polymerized. Suitable monomers include, but are not limited to, pyrrole, aniline, N,N-dimethylaniline, furan, pyridine, catechol, naphthalene, azulene, pyrene, 2,6-dimethylphenol, fluorine, carbazole, indole, 10-methoxy-5H-dibenzo-[B,F]-azepine, and diphenylacetylene. In certain embodiments, the monomer may be substituted. Suitable substituents include, but are not limited to, alkyl groups, halo (such as fluoro or chloro), amino and alkoxy. Suitably, the monomer is present in a concentration of from about 0.005 M to about 0.5 M. In certain embodiments, the monomer is present in a concentration of from about 0.005 M to about 0.2 M. In certain embodiments, the conductive monomer is oligomerized prior to contacting it with the oxidant.

As used herein, an “alkyl” group is a saturated or unsaturated carbon chain having 1 to 18 carbon atoms. An alkyl group may be branched or unbranched and it may be substituted or unsubstituted. Suitably, the alkyl group may be a lower alkyl group of from 1 to 4 carbon atoms, such as methyl, ethyl, propyl, isopropyl or butyl. “Alkylene” refers a divalent alkyl group.

As used herein, an “alkoxy” group refers to the group —O—R wherein R is alkyl.

As used herein, an “amino” group refers to the group —NR′R′ wherein each R′ is, independently, hydrogen or alkyl. The two R′ groups may themselves be linked to form a ring.

As used herein, “halo” is fluoro, chloro, bromo, or iodo.

Substituents may also be themselves substituted.

Suitable primary and secondary oxidants include, but are not limited to, ozone, iron(III) chloride, copper(II) chloride, copper(II) sulfate, ammonium persulfate, silver nitrate, p-benzoquinone, potassium permanganate, and vanadium(V) oxide. Suitably, the ozone may be present in a concentration of about 18% by weight in oxygen. Alternatively, the ozone may be present in a concentration of about 5% to about 30% by weight in oxygen. Secondary oxidants may be used, e.g., if a porous structure is desired. In one embodiment, the secondary oxidant may be added after the primary oxidant. Alternatively, both oxidants may be added at about the same time. For example, iron(III) chloride may be added to the reaction mixture in sufficient quantity to generate a concentration of 1 M FeCl₃ in the reaction mixture.

Suitable aqueous solvents include those generally known to one of ordinary skill in the art. In one embodiment, the aqueous solvent comprises water. In certain embodiments, the aqueous solvent further comprises additional polar solvents, such as alcohol, e.g. ethanol. In certain embodiments, the aqueous solvent comprises at least about 10% water.

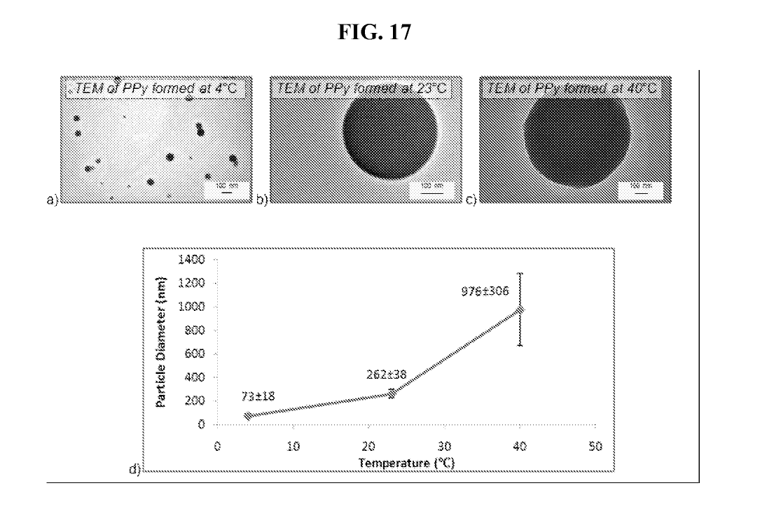

The method of the present invention may be performed at a temperature of from about −15° C. to about 40° C. In certain embodiments, the temperature may be about 4° C. to about 25° C. Alternatively, the temperature may be about 0° C. to about 4° C. Reaction temperature may have an effect on particle size, with colder temperatures producing smaller particles as shown in FIG. 17.

In addition, the pH may be from about 1.5 to about 8 or about 2 to about 7 or about 3 to about 7. The pH may be adjusted by the addition of hydrochloric acid or sodium hydroxide.

Without wishing to be bound by theory, it is believed that certain other reaction variables may play a role in the formation of stable nanoparticles:
1. solubility of the monomer in water;
2. density of the monomer and resulting polymer; and
3. hydrophobic or hydrophilic nature of the monomer and polymer.

Thus, in certain embodiments, the monomer may have a density of from about 0.8 to about 1.2. For example, pyrrole has a density of 0.97 g/ml, which is very close to that of water. Suitably, the monomer is only slightly soluble in water.

In one embodiment, the conductive polymer nanoparticles are used to stabilize other particles such as silver, silica, gold, iron etc. Suitably, the particle may be added to the reaction mixture after the oxidant exposure is complete and the excess oxidant removed. The reaction mixture is then stirred for a period of time. In some embodiments, the reaction mixture is stirred for 12 to 24 hours or 12 to 36 hours. In certain embodiments, the particle may be added in salt form, e.g. silver nitrate.

Dopants may be added during the synthesis to maintain charge neutrality. Suitable dopants include any negatively charged ion.

In certain embodiments, the nanoparticles may be present in various different morphologies, such as nanowires, nanorods, nanotubes, nanospheres or nanocapsules.

### Characterization of the Nanoparticles

The resulting polymer may be characterized by various techniques well-known to one of ordinary skill in the art. Such techniques include, but are not limited to, Fourier transform infrared spectroscopy (FTIR), nuclear magnetic resonance spectroscopy (NMR), and ultra-violet visible spectroscopy (UV-Vis).

For example, UV-Vis may be performed to confirm the presence of polarons and biopolarons through electron excitation from the ground state to an excited state. FTIR may be utilized to provide the absorption peaks of infrared spectra that correspond to the frequencies of vibration between the bonds of atoms comprising the nanoparticles.

The stability of the conductive polymer nanoparticles may also be studied using various techniques well-known to those of ordinary skill in the art. Such techniques include, but are not limited to, scanning electron microscopy (SEM), transmission electron microscopy (TEM), zeta potential, and atomic force microscopy (AFM). In one embodiment, the resulting nanoparticles are smooth or almost smooth in appearance.

In certain embodiments, the stabilized polymer nanoparticles are not stabilized electrostatically or sterically. As used herein, the term “stabilized” means that the nanoparticles are substantially non-agglomerated.

Further, in certain embodiments, the conductive polymer nanoparticles have a zeta potential of about zero. Alternatively the conductive polymer nanoparticles have a zeta potential of from about −0.5 to about 0.5. In some embodiments, the nanoparticles are near neutral in charge.

### Electrochemical Characterization of the Nanoparticles

Several different electrochemical techniques may be used to investigate the electrochemical properties of the synthesized nanoparticles. The first electrochemical assessment will be the measurement of conductivity. Initial studies via the TEM will provide insight into the electron density and will be used in conjunction with the UV-Vis and 4-point probe conductivity measurements to quantify the conductivity of the nanospheres. Conductive atomic force microscopy (C-AFM), which is able to measure conductivities of 1 pA to 1 μA, will be used to characterize pressed pellets and of the nanospheres for surface morphology and conductivity. Also, it is proposed that the nanospheres be embedded in a conductive resin and placed in solution in the in-situ cell for electrochemical atomic force microscopy (E-AFM). During E-AFM, a cycle potential will be applied with periodic imaging of the surface of the nanosphere.

Another technique that will be used will involve drip coating the nanoparticle dispersions onto a disk electrode and then performing cyclic voltammetry (CV) on that modified electrode. Platinum and glassy carbon disk electrodes will be used for this experiment. If this technique is not successful in obtaining cyclic voltammograms, the nanoparticle dispersions will be centrifuged, the water will be decanted, and the nanoparticles will be dried. The dry nanoparticles will then be added to a carbon paste electrode in order to obtain a cyclic voltammogram.

A rotating disk electrode (RDE) will also be used to characterize the electrochemical behavior of the nanoparticles. By using a disk in ring electrode in which the polypyrrole nanoparticles are coated onto the central disk, the de-doping processes as a result of polymer reduction can be monitored. The central disk will be held at a reducing potential and the platinum ring that surrounds the central disk will be held at an oxidizing potential at which the dopant will be oxidized. The spinning motion of the electrode will force dopants released from the nanoparticles to flow out to the platinum ring where they will undergo a reaction and be detected as an electrical current. This experiment will yield information about the amount of dopant being incorporated into the polypyrrole as well as the reversibility of the doping and de-doping processes.

A scanning electrochemical microscope (SECM) will be used to perform electrochemical measurements on individual nanoparticles. Recent advancements in the construction of probes for the SECM allow measurements to be made on the nano-scale. Both platinum and carbon fiber electrodes have been constructed with diameters that would be small enough to make electrochemical measurements on individual particles similar in size or smaller than the particles that have already been synthesized in this research.[82-84] These techniques would involve the fire polishing of carbon fiber electrodes or physical polishing of platinum wire to obtain a suitable diameter. The probes would be characterized using the SECM and cyclic voltammetry in a solution containing a species with known electrochemical behavior such as Ru(NH₃)₆. With these probes, cyclic voltammograms of individual nanoparticles could be obtained that would then allow comparison of the properties of the individual nanoparticles to bulk materials. Other dopant release experiments would also be possible with the SECM on the nanoscale.

### Uses for the Nanoparticles

The conductive polymer nanoparticles formed by the process of the present invention may be used in the same manner as conductive polymer nanoparticles formed by traditional routes. Many of these uses would be known to one skilled in the art. In one embodiment, the conductive polymer nanoparticles may be used as a coating to stabilize other particles. For example, the conductive polymer nanoparticles may be used to stabilize particles such as silver, silica, gold, iron, etc. The conductive polymer nanoparticles may also be used as corrosion inhibitors in paints or other coatings.

It is to be understood that the invention is not limited in its application to the details of construction and the arrangement of components set forth in the following description. The invention is capable of other embodiments and of being practiced or of being carried out in various ways. Also, it is to be understood that the phraseology and terminology used herein is for the purpose of description and should not be regarded as limiting.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any nonclaimed element as essential to the practice of the invention.

It also is understood that any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this application.

Further, no admission is made that any reference, including any patent or patent document, cited in this specification constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinency of any of the documents cited herein.

### EXAMPLES

Exemplary embodiments of the present invention are provided in the following examples. The examples are not intended in any way to otherwise limit the scope of the invention.

### Example 1

### Preparation and Characterization of Polypyrrole Nanoparticles

### Experimental

Pyrrole was obtained from Sigma Aldrich and was freshly distilled before use. Millipore 18.2 MΩ water was the solvent used for the reactions. Ozone was obtained by flowing pure dried oxygen supplied by Air Gas through a model ATLAS 30 C ozone generator supplied by Absolute Ozone.

Particle size measurements were carried out using a NICOMP 380 submicron particle sizer supplied by Particle Sizing Systems. A Gaussian analysis was applied to all data.

For the TEM images, 300 mesh Formvar/carbon coated grids were dipped into a solution including the particles and immediately wicked off using filter paper. After allowing the grid to dry, images were obtained using a JEOL JEM-100CX II Transmission Electron Microscope at 80 keV.

UV Vis spectra of the polypyrrole nanoparticles in water were recorded on Varian-5000 UV-Vis-NIR spectrophotometer.

Thermal degradation analysis of the samples was performed using a thermogravimetric analysis instrument TGA Q 500 supplied by TA Instruments. The samples were heated from room temperature to 800° C. at a heating rate of 20° C./min. The obtained results were analyzed using the software, Universal Analysis 2000.

A Nicolet FT-IR spectrometer was used for the FT-IR characterization.

A Veeco Dimension 3100 atomic force microscope (“AFM”) with contact mode and current sensing probe was used for conductive AFM (“C-AFM”) measurements to characterize pressed pellets of the nanoparticles for surface morphology and conductivity. C-AFM can be applied to materials with conductivity of about 1 pA to about 1 μA.

Zeta potential was measured in water using a Zetasizer (Malvern Instruments, Worcestershire, U.K.). All measurements were recorded at 25° C.

Samples were prepared for scanning electron microscopy (“SEM”) by sprinkling onto carbon tape attached to aluminum mounts. The sample was then coated with gold using a Balzers SCD 030 sputter coater. Images were obtained using a JEOL JSM-7600F Scanning Electron Microscope. Magnification, accelerating voltage values and micron bars are listed in each figure.

Conditions for four synthesis reactions that were performed are shown in Table 1.

TABLE 1
Summary of initial reactions.

| | | Ozone Exposure | Temperature |
|---|---|---|---|
| Reaction | Pyrrole (M) | (seconds) | (° C.) |
| A | 0.17 | 60 | 23 |
| B | 0.17 | 60 | 4 |
| C | 0.17 | 30 | 23 |
| D | 0.085 | 60 | 23 |

The synthesis procedure for the first set of reactions was as follows: 100 ml of Millipore water was placed in a 125 ml Erlenmeyer flask followed by 1.35 g of pyrrole. In the case of reaction D, 0.675 g of pyrrole was added. The mixture was then stirred until the pyrrole dissolved. Oxygen was provided to the ozone generator at a pressure of 20 psi and a flow rate of 0.2 liters/minute. According to the literature provided by Absolute Ozone, this flow rate should be producing an oxygen/ozone mixture that is 18% ozone by weight. For reactions A and D, the oxygen/ozone mixture was bubbled through the pyrrole solution for 60 seconds. For reaction C the oxygen/ozone mixture was bubbled through the pyrrole solution for 30 seconds. After the ozone exposure was complete, any remaining ozone in the flask was removed by gently blowing a stream of air from a compressed air line. The flasks were then sealed with a rubber stopper and allowed to sit for 4 days.

The procedure for reaction B was similar except that prior to the pyrrole being added to the Millipore water, the flask was placed in an ice bath until the water reached a temperature of 4° C. Pyrrole was then added and stirred. The oxygen/ozone mixture was then bubbled through the pyrrole solution while it remained in the ice bath. After ozone exposure, remaining ozone was removed with a stream of compressed air and the flask was sealed with a stopper and placed in a refrigerator at a temperature of 4° C. for 4 days.

The reaction procedure described above was followed for all the reactions described herein; the experimental variants included: temperature, molar concentration, and ozone exposure time. After the results from the first set of reactions were obtained, another series of reactions, shown in Table 2, was carried out to determine factors affecting the stability and formation of the nanoparticles. The reactions in Table 2 were performed at room temperature using the same pressure and flow rate as the previous reactions from Table 1, as described above.

TABLE 2
Reactions for studying zeta potential measurement
and particle size behavior as a function of
monomer concentration and ozone exposure.

| Reaction | Conditions |
|---|---|
| | 0.17 Molar Pyrrole |
| R-1 | 30 Seconds Ozone Exposure |
| R-2 | 60 Seconds Ozone Exposure |
| R-3 | 120 Seconds Ozone |
| | 0.34 Molar Pyrrole |
| R-4 | 30 Seconds Ozone Exposure |
| R-5 | 60 Seconds Ozone Exposure |
| R-6 | 120 Seconds Ozone |
| | 0.51 Molar Pyrrole |
| R-7 | 30 Seconds Ozone Exposure |
| R-8 | 60 Seconds Ozone Exposure |
| R-9 | 120 Seconds Ozone |
| | 0.68 Molar Pyrrole |
| R-10 | 30 Seconds Ozone Exposure |
| R-11 | 60 Seconds Ozone Exposure |
| R-12 | 120 Seconds Ozone |
| | 0.85 Molar Pyrrole |
| R-13 | 30 Seconds Ozone Exposure |
| R-14 | 60 Seconds Ozone Exposure |
| R-15 | 120 Seconds Ozone |

Additional reactions were performed to investigate the effect of pH in conjunction with ozone exposure on the synthesis reaction. The conditions used for these reactions are provided in Table 3.

TABLE 3
Reactions studying the effect of pH and ozone exposure
on the synthesis of polypyrrole nanoparticles.

| | | | Ozone Exposure | Temperature |
|---|---|---|---|---|
| Reaction | Pyrrole (M) | pH | Time (seconds) | (° C.) |
| R-16 | 0.17 | 2 | 60 | 23 |
| R-17 | 0.17 | 4 | 60 | 23 |
| R-18 | 0.17 | 6 | 60 | 23 |
| R-19 | 0.17 | 8 | 60 | 23 |
| R-20 | 0.17 | 10 | 60 | 23 |
| R-21 | 0.17 | 12 | 60 | 23 |
| R-22 | 0.17 | 2 | 60 | 0 |
| R-23 | 0.17 | 1.8 | 60 | 0 |
| R-24 | 0.17 | 1.65 | 60 | 0 |
| R-25 | 0.17 | 1.5 | 60 | 0 |
| R-26 | 0.17 | 1.3 | 60 | 0 |
| R-27 | 0.17 | 1.8 | 60 | 0 |
| R-28 | 0.17 | 1.6 | 60 | 0 |
| R-29 | 0.17 | 1.4 | 60 | 0 |
| R-30 | 0.17 | 1.8 | 120 | 0 |
| R-31 | 0.17 | 1.6 | 120 | 0 |
| R-32 | 0.17 | 1.4 | 120 | 0 |
| R-33 | 0.17 | 1.8 | 240 | 0 |
| R-34 | 0.17 | 1.6 | 240 | 0 |
| R-35 | 0.17 | 1.4 | 240 | 0 |
| R-36 | 0.17 | 1 | 480 | 0 |
| R-37 | 0.17 | 6.2 | 60 | 0 |
| R-38 | 0.17 | 3.7 | 60 | 0 |
| R-39 | 0.17 | 3.0 | 60 | 0 |
| R-40 | 0.17 | 2.0 | 60 | 0 |
| R-41 | 0.17 | 1.7 | 60 | 0 |
| R-42 | 0.17 | 1.5 | 60 | 0 |
| R-43 | 0.17 | 1.1 | 60 | 0 |

### Results and Discussion

The first reactions performed (Table 1) were a survey to determine what factors may have an influence on the particle size of the products of the reaction. The results from the Gaussian analysis of the particle size distributions from the various reactions are provided in Table 4. These results indicate that the duration of ozone exposure has a moderate effect on the mean particle size. When the ozone exposure time was reduced from 60 seconds to 30 seconds, the mean particle size was reduced by 58 nm. However, with this moderate decrease in the mean diameter of the particles, there was a large increase in the standard deviation and, therefore, a decrease in the uniformity of the measured particle diameter.

Temperature also had an influence on the resulting particle size. With a number weighted mean particle diameter of 73 nm for reaction B (Table 4), a drop in temperature of 19° C. resulted in a drop in mean particle size of 251 nm and reduced the particle size to a value below 100 nm. The curves of the data from which these numbers were calculated are provided in FIGS. 1-4.

Referring to FIGS. 1-4, the plots indicate that particle distributions achieved from these reactions all approximate Gaussian behavior. That these peaks are all Gaussian in nature indicates that there are likely not any large mechanistic differences induced by the variables that were changed in the various reactions. A bimodal distribution, for example, would indicate that some effect that was causing a drastic difference in the products was influencing the products of the reactions. The plots also indicate that the decrease in temperature in reaction B narrowed the distribution as well as shifted the particle size distribution of the polypyrrole nanoparticles to smaller diameters.

TABLE 4
The number and volume weighted mean particle diameter
and the standard deviations for reactions A-D.

| | | Mean | Standard |
|---|---|---|---|
| Reaction | Mean Weighting | Diameter (nm) | Deviation (nm) |
| A | Number | 324 | 16 |
| | Volume | 325 | 16 |
| B | Number | 73 | 18 |
| | Volume | 88 | 22 |
| C | Number | 266 | 78 |
| | Volume | 373 | 109 |
| D | Number | 288 | 32 |
| | Volume | 301 | 34 |

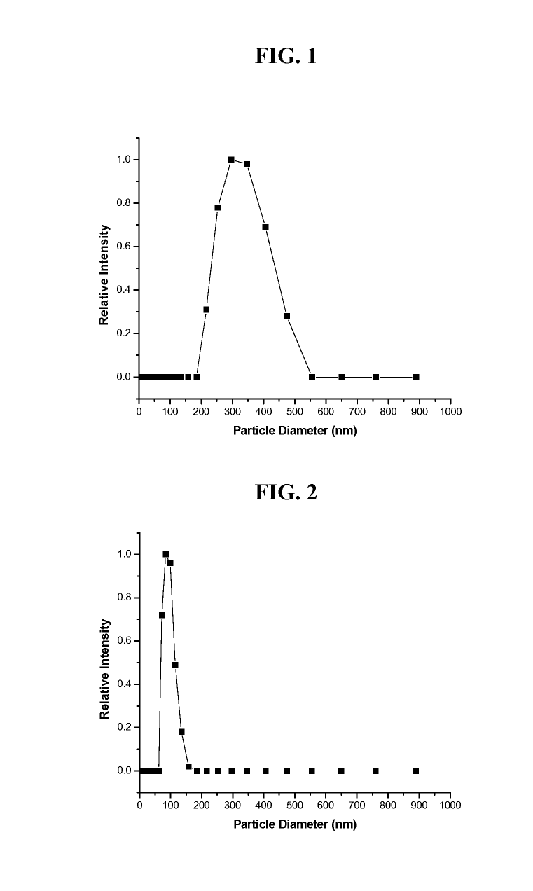

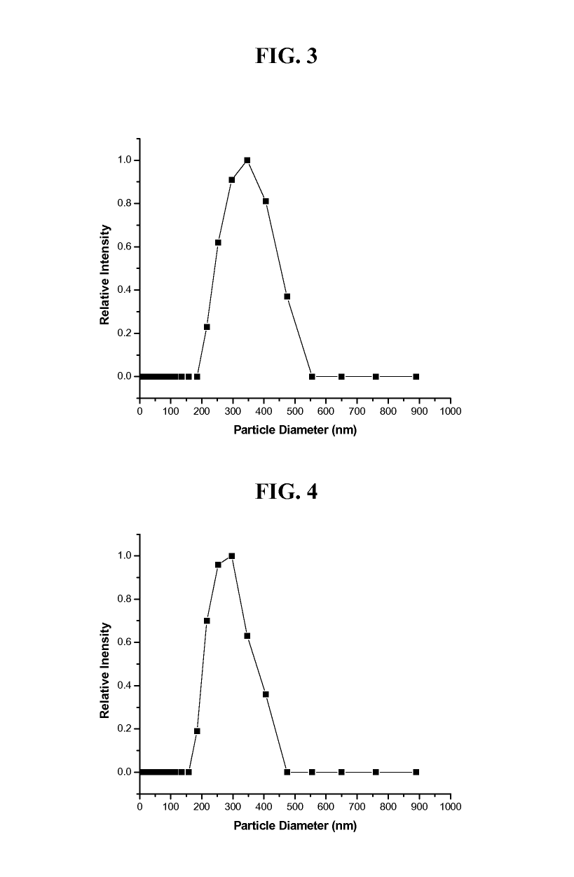

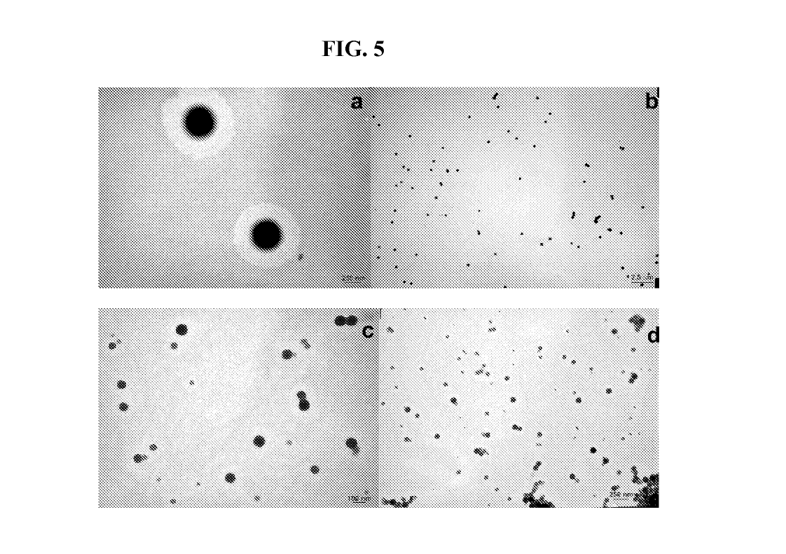

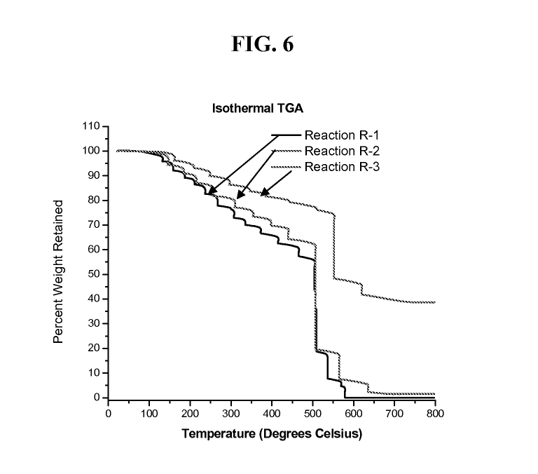

The analysis of reactions A and B via a transmission electron microscope is provided in FIG. 5. Referring to FIG. 5, these images show that reactions A and B yielded particles that were spherical in nature with very little agglomeration. The particle sizes presented in FIGS. 1 and 2 were verified with the TEM results. The particles shown in FIG. 5 display significant electron density, as indicated by the opacity of the particles. Though not wishing to be bound by a particular theory, this may be an indication that there is a significant conjugation of the polypyrrole within the particles. It is known that many nanosized polymer particles, such as poly(methyl methacrylate), appear to be somewhat translucent under the TEM due to low electron density. In contrast to this, conductive polymers that have a high degree of unsaturation can lead to much higher electron densities. The results above are in good agreement with other TEM results for conductive polymer nanoparticles.

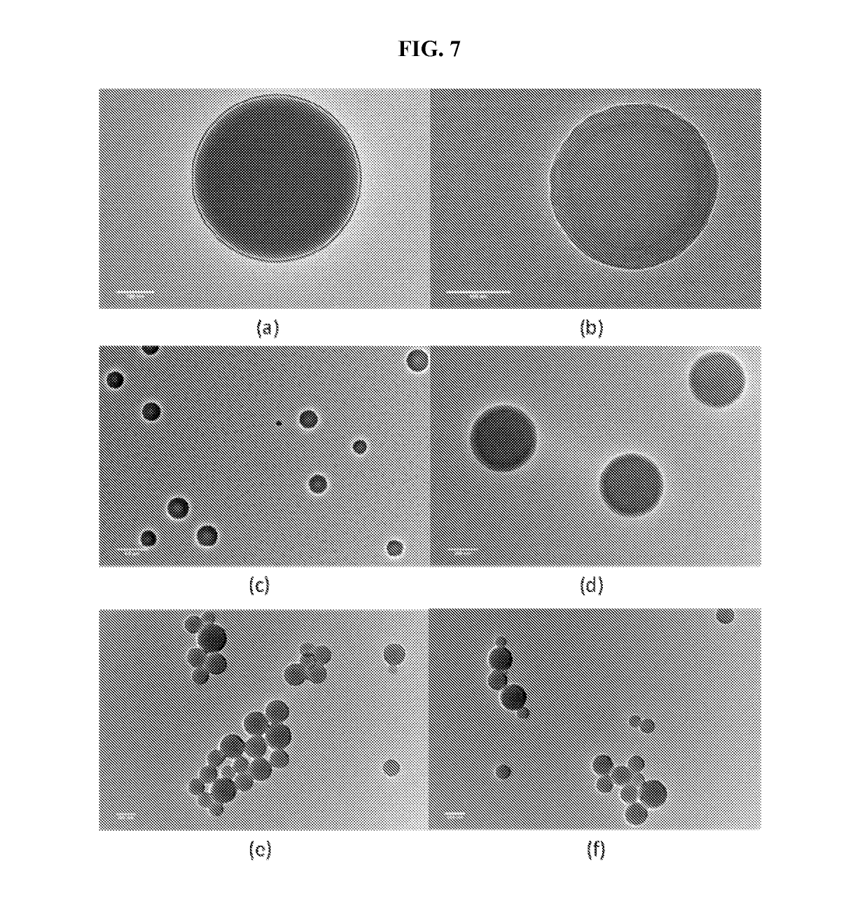

After the aforementioned results were obtained for reactions A-D, further study was carried out to investigate any correlation between the monomer concentration, ozone exposure length, and particle size at room temperature (see Table 2). The TGA results for reactions R1-R3 are provided in FIG. 6. Referring to FIG. 6, with longer ozone exposure times, an increase in the thermal stability of the product resulted. Though not wishing to be bound by a particular theory, this behavior could be indicative of a higher molecular weight product, indicating that the ozone is initiating cationic radical polymerization of the polypyrrole similar to other initiators that act as oxidizing agents.

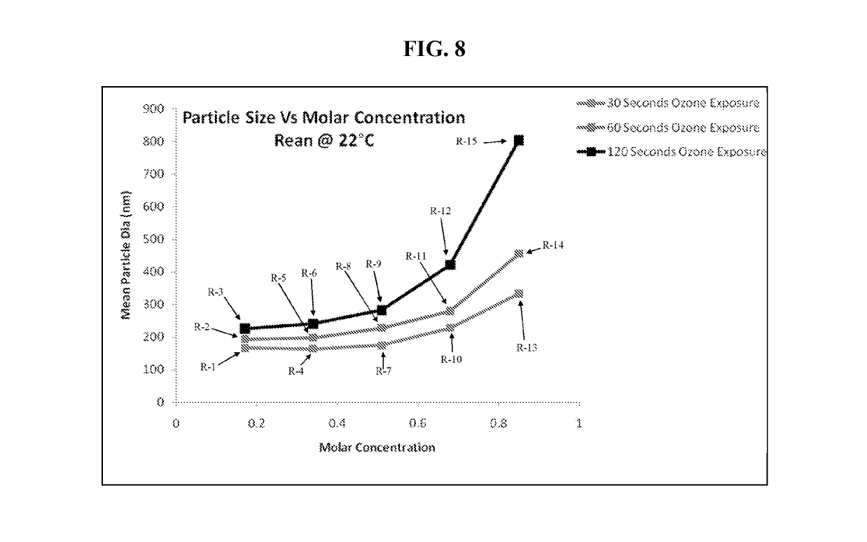

TEM results for selected reactions from Table 2 are shown in FIG. 7. Referring to FIG. 7, these results show that there is a layer that has formed on the outside of the particles, despite the absence of a surfactant in the synthesis reaction. Though not wishing to be bound by a particular theory, it is thought that this layer may be responsible for the stabilization of the particle dispersion. This outer layer may comprise more polar overoxidized polypyrrole which could act as a steric stabilizer. As shown in FIG. 7, the outer layer varies in thickness due to varying synthesis conditions, which may be an explanation for observed agglomeration of the particles. For example, the layer observed on the particles produced from reaction R-10 appears to be thinner than the layers that can be observed in the other images, which may be a reason why this reaction produced agglomerated nanoparticles. More evidence and discussion on this hypothesis is shown below.

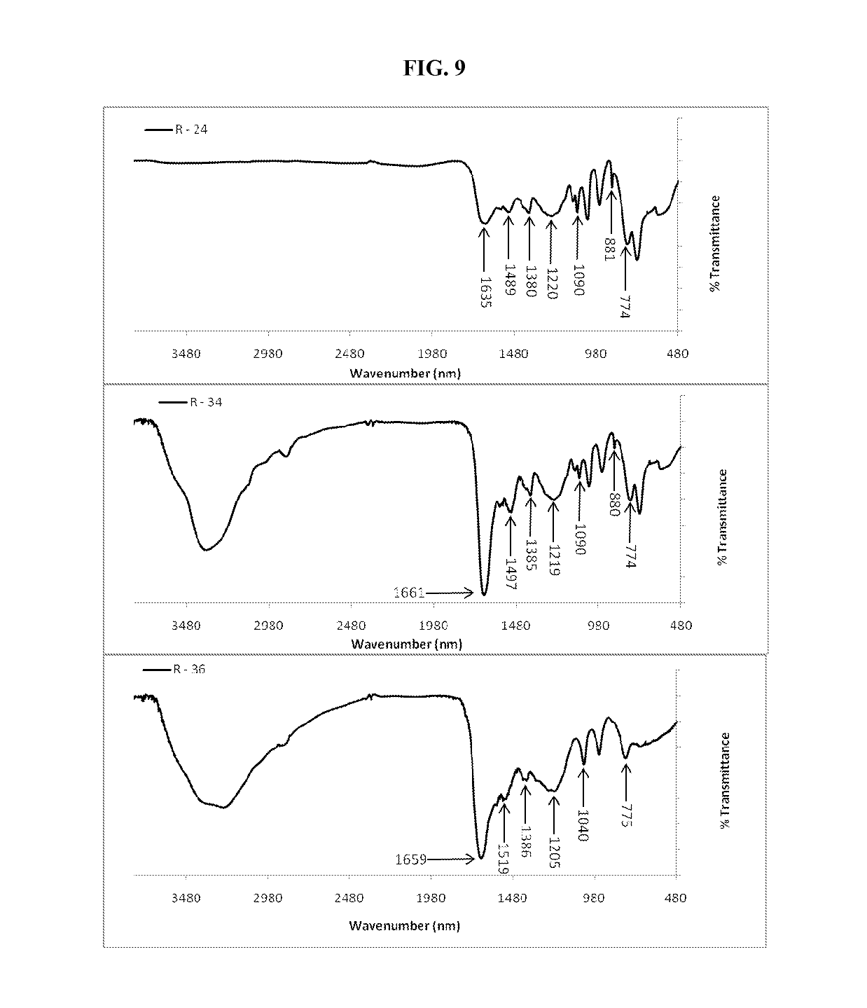

The influence of monomer concentration and ozone exposure is presented in FIG. 8. As shown in FIG. 8, increased ozone exposure times and higher monomer concentration resulted in larger particle sizes at room temperature. Furthermore, the length of time that the reaction was exposed ozone had a large affect on particle size at higher monomer concentrations. Though not wishing to be bound by a particular theory, these results may indicate that as the concentration of nanoparticles in the dispersions increases, the stability mechanism of the dispersion begins to become less effective, leading to large agglomerations of particles; this may simply be due to a larger number of collisions between the particles leading to a higher agglomeration rate.

To determine the mechanism by which the nanoparticles are stabilized and whether the layer on the outside of the particles may be involved, zeta potential measurements were performed on the dispersions at a pH of 4.5 and at pH ranging from 4.2 to 1.2. The zeta potential results of all the reactions from Table 2 can be seen in Table 5 and Table 6.

TABLE 5
Zeta potential and yield data for reactions R-1 through R-15.

| Reaction | | Zeta potential | Yield (gm) |
|---|---|---|---|
| | 0.17 Molar | | |
| R-1 | 30 Seconds Ozone Exposure | 0.069 | 0.01 |
| R-2 | 60 Seconds Ozone Exposure | −0.075 | 0.03 |
| R-3 | 120 Seconds Ozone | 0.504 | 0.02 |
| | 0.34 Molar | | |
| R-4 | 30 Seconds Ozone Exposure | −0.077 | 0.02 |
| R-5 | 60 Seconds Ozone Exposure | −0.128 | 0.03 |
| R-6 | 120 Seconds Ozone | 0.273 | 0.02 |
| | 0.51 Molar | | |
| R-7 | 30 Seconds Ozone Exposure | −0.077 | 0.03 |
| R-8 | 60 Seconds Ozone Exposure | −0.004 | 0.04 |
| R-9 | 120 Seconds Ozone | −0.239 | 0.04 |
| | 0.68 Molar | | |
| R-10 | 30 Seconds Ozone Exposure | 0.060 | 0.03 |
| R-11 | 60 Seconds Ozone Exposure | 0.045 | 0.03 |
| R-12 | 120 Seconds Ozone | −0.299 | 0.04 |
| | 0.85 Molar | | |
| R-13 | 30 Seconds Ozone Exposure | 0.105 | 0.03 |
| R-14 | 60 Seconds Ozone Exposure | 0.127 | 0.02 |
| R-15 | 120 Seconds Ozone | −0.142 | 0.03 |

TABLE 6
Zeta potential for reactions from R-37 to R-43.

| | pH Before | pH After | Zeta |
|---|---|---|---|
| Reaction | Reaction | Reaction | Potential (mV) |
| R-37 | 6.2 | 4.2 | 0.036 |
| R-38 | 3.7 | 4 | −0.062 |
| R-39 | 3 | 3.5 | −0.090 |
| R-40 | 2 | 2.2 | 0.126 |
| R-41 | 1.7 | 1.8 | −0.040 |
| R-42 | 1.5 | 1.5 | −0.013 |
| R-43 | 1.1 | 1.2 | −0.094 |

As shown in Tables 5 and 6, for all of the measured reactions, the zeta potential was very near 0 V, which indicates that electrostatic repulsion is not likely the method of stabilization. Furthermore, no effect was observed on zeta potential with change in pH. Therefore it is likely that the stability of the particles may be attributed to steric stabilization. According to Cataldo et al., (Polymer Degradation and Stability, 2003. 82(3): p. 487-495), ozone slowly forms amide ketones on the α carbons and hydroxide groups on the β carbons of a polypyrrole chain with some ring scission. This may be another explanation for the inherent stability that appears to be imparted to the nanoparticles.

Though not wishing to be bound by a particular theory, if the layer surrounding the nanoparticles were comprised of overoxidized polypyrrole, it may act as a sterically-stabilizing layer. The ketone and hydroxyl functional groups that may form on the polypyrrole chains as a result of overoxidation may cause the outer layers of the particles to be more polar and, therefore, more hydrophilic. This hydrophilicity may allow the chains to relax in the surrounding water. Aggregation may then require these surrounding chains to take on less relaxed conformations which may result in a decrease in entropy. Aggregation may therefore be entropically unfavorable. This hypothesis is further supported by the presence of a carbonyl peak and a hydroxyl peak in the FTIR results in FIG. 9.

Referring to FIG. 9, the bands at 1563 (2,5-substituted pyrrole) and 1436 cm⁻¹ may be assigned to polypyrrole ring vibrations. The bands at 1345, and 1074 cm⁻¹ may be corresponding to ═C—H in plane vibrations while the band at 885 cm-1 may correspond to out of plane vibrations indicating polymerization of pyrrole. The absorption peak at 1658 cm-1 may correspond to a —C═O linkage. The C═O structure at the β-C of pyrrole ring is typically due to the overoxidation of polypyrrole.

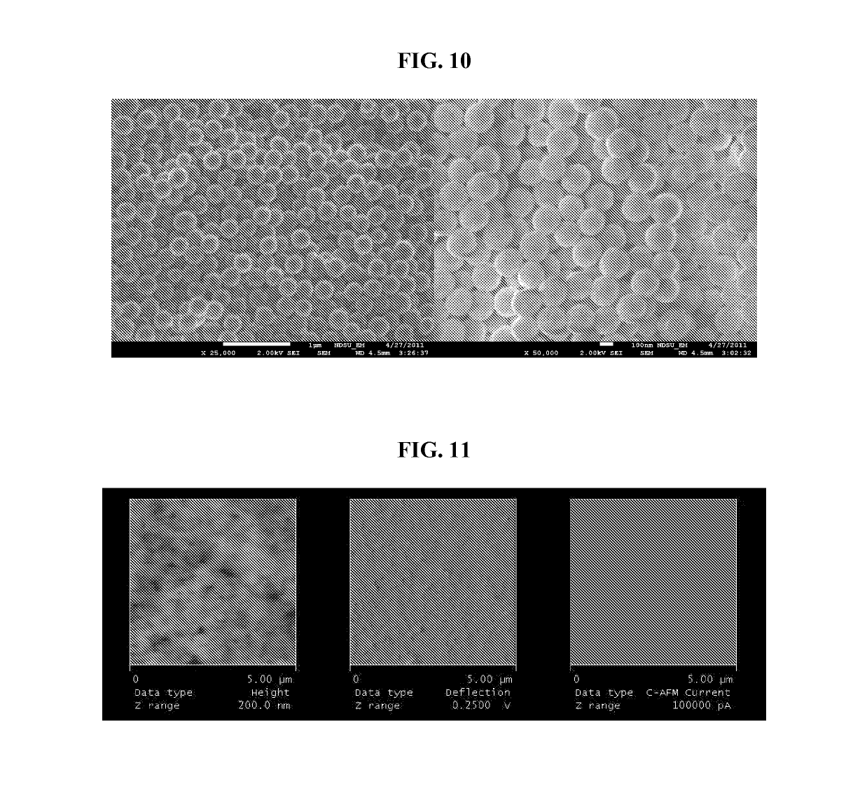

To further explore the layer surrounding the polypyrrole nanoparticles, high resolution SEM images of the nanoparticles were obtained in order to better determine the surface morphology of the outside layer surrounding them. These images can be seen in FIG. 10.

Referring to FIG. 10, these images show that the nanoparticles are fairly uniform in size and shape and that the outside layer surrounding the nanoparticles is quite smooth; this is not necessarily supportive of a steric stabilization mechanism, as one may expect to see a rough surface due to the relaxed surface of the particles. Though not wishing to be bound by a particular theory, one explanation may be that as the water evaporated from the surface of the nanoparticles, the polymer chains on the outer layer of the particles no longer had a medium to relax into and therefore took on a less relaxed conformation forming a surface similar to a cast film.

The presence of overoxidized polypyrrole was also verified using the conductive AFM technique. In all of the fifteen reactions in Table 2, the synthesized product does not exhibit conductivity that is measurable with this instrument. A typical set of images collected is shown in FIG. 11. Referring to FIG. 11, it is the far right image that would show measurable current as white areas in the image. The current detection threshold for this instrument is about 1 pA to about 1 μA. Though not wishing to be bound by a particular theory, if overoxidized oligomers are forming an insulating layer around the particles with more conductive polypyrrole at the center, it may disrupt conduction through a pressed pellet of the product and therefore prevent conductivity in the sample. This insulating behavior may be due to the presence of the carbonyl functional groups which disrupt the conjugation of polypyrrole chains and therefore reduce the conductivity of polypyrrole.

Though not wishing to be bound by a particular theory, the overoxidation may be due to the use of water as the solvent. Novak has suggested in his work that carbonyl linkages form due to the reaction of pyrrole with water and hydroxy radicals which are in abundance when ozone is dissolved in water (Electrochimica Acta, 1992. 37(7): p. 1227-1230). This phenomenon is pH dependent, however, and overoxidation is thermodynamically more favorable at a basic pH. Thus, by adjusting the pH with hydrochloric acid, a conductive product may be obtained. An additional benefit of lower pH may be to decrease the rate of decomposition for ozone. Ozone dissociation in water is initiated by negatively charged OH ions, by decreasing the pH of the reaction solution, this reaction can be slowed, which may result in less overoxidation of the polypyrrole as well.

Reactions demonstrating the effect of pH and ozone exposure on the synthesis of polypyrrole nanoparticles are summarized in Table 3. The effect of pH was studied using HCl and NaOH to adjust the pH of the synthesis solutions prior to ozone exposure. The dispersions produced from these reactions were observed visually for colloidal stability and with UV Vis spectroscopy to detect the presence of bipolarons which would indicate conductivity. Solutions of pyrrole in water were prepared at a pH of 2, 4, 6, 8, 10, and 12.

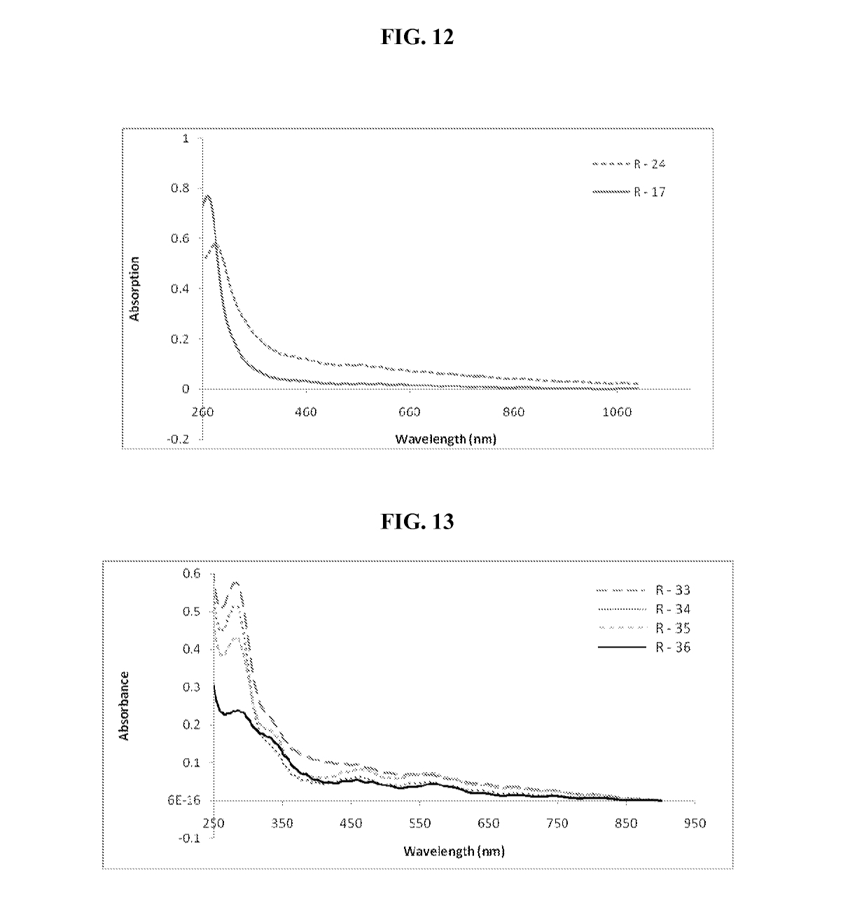

It was observed visually that increasing the pH of the reaction above a pH of 4 caused agglomeration of the nanoparticles and that the least amount of agglomeration was observed at a pH 2. Referring to FIG. 12, by analyzing the UV Vis spectra of the reactions R-17 and R-24, the peaks at approximately 294 nm show that the dispersions of nanoparticles contain large amounts of terpyrrole oligomers. By reducing the pH of the reaction, the peak for terpyrrole oligomers became less intense and was shifted slightly towards higher wavelengths. Though not wishing to be bound by a particular theory, this drop in intensity may indicate slightly less pyrrole monomer is being polymerized into terpyrrole.

Reactions R-22 through R-26 were carried out from a pH of 2 to a pH of 1.3 to determine if the stability or conductivity of the nanoparticles could be improved. The ozone exposure time was also increased for these reactions in an effort to increase the molecular weight of the polypyrrole. Visual assessment suggested that the dispersions were not stable below a pH of 1.65. Therefore, while it may be beneficial to perform the synthesis reaction at a low pH, as this would provide significant chloride ions from the hydrochloric acid to act as dopant ions if the polypyrrole chains were oxidized to a conductive state, too low of a pH can cause agglomeration.

FIG. 13 provides the results for the increased ozone exposure time and reduced pH on the UV-Vis spectra of the products. As shown in FIG. 13, with reduction in pH, the terpyrrole peaks at approximately 300 nm were reduced, which suggests a decrease in the amount of terpyrrole in the final product. The broad band at 475 nm, which has been assigned to the pi-pi* transition of polypyrrole, indicates that higher molecular weight polypyrrole is produced. The peaks at 475 nm also show bipolaron absorption due to Cl⁻ ion doping. However, as earlier reported, the increase in reaction time is prone to producing agglomeration of nanoparticles.

### Example 2

### Preparation and Characterization of Polyaniline Nanoparticles

### Experimental

Aniline was obtained from Sigma Aldrich. Millipore 18.2 MΩ water was the solvent used for the reactions. Ozone was obtained by flowing pure dried oxygen supplied by Air Gas through a model ATLAS 30 C ozone generator supplied by Absolute Ozone.

Particle size measurements were carried out using a NICOMP 380 submicron particle sizer supplied by Particle Sizing Systems. A Gaussian analysis was applied to all data.

UV Vis spectra of the polypyrrole nanoparticles in water were recorded on Varian-5000 UV-Vis-NIR spectrophotometer.

Thermal degradation analysis of the samples was performed using a thermogravimetric analysis instrument TGA Q 500 supplied by TA Instruments. The samples were heated from room temperature to 800° C. at a heating rate of 20° C./min. The obtained results were analyzed using the software, Universal Analysis 2000.

A Nicolet FT-IR spectrometer was used for the FT-IR characterization.

A Veeco Dimension 3100 atomic force microscope (“AFM”) with contact mode and current sensing probe was used for conductive AFM (“C-AFM”) measurements to characterize pressed pellets of the nanoparticles for surface morphology and conductivity. C-AFM can be applied to materials with conductivity of about 1 pA to about 1 μA.

Zeta potential was measured in water using a Zetasizer (Malvern Instruments, Worcestershire, U.K.). All measurements were recorded at 25° C.

Samples were prepared for scanning electron microscopy (“SEM”) by sprinkling onto carbon tape attached to aluminum mounts. The sample was then coated with gold using a Balzers SCD 030 sputter coater. Images were obtained using a JEOL JSM-7600F Scanning Electron Microscope. Magnification, accelerating voltage values and micron bars are listed in each figure.

In a typical experiment, a solution of aniline was prepared in 18.2 MΩ Millipore water. Hydrochloric acid and sodium hydroxide were used to adjust the pH. Oxygen was provided to the ozone generator at a pressure of 20 psi and a flow rate of 0.2 liters/minute. According to the literature provided to Absolute Ozone, this flow rate should be producing an oxygen/ozone mixture that is 18% ozone by weight. The oxygen/ozone mixture was bubbled through the 100 ml solution for 60 seconds. After the ozone exposure was complete any remaining ozone in the flask was removed by gently blowing a stream of air from a compressed air line over the reaction solution until fuming ceased. The majority of reactions presented in this Example were performed at room temperature in 250 ml Erlenmeyer flasks, but for the temperature controlled reactions, a 250 ml jacketed kettle was used.

Conditions for various reactions are shown in Tables 7 and 8.

TABLE 7
Reactions with Variation of Ozone Exposure

| | | Ozone | | |
|---|---|---|---|---|
| | Aniline | Exposure | Temperature | pH before |
| Reactions | (M) | (Seconds) | (° C.) | reaction |
| A | 0.02 | 60 | 23 | 7.6 |
| B | 0.02 | 120 | 23 | 7.6 |
| C | 0.02 | 240 | 23 | 7.6 |
| D | 0.02 | 300 | 23 | 7.6 |
| E | 0.02 | 360 | 23 | 7.6 |
| F | 0.02 | 420 | 23 | 7.6 |
| G | 0.02 | 480 | 23 | 7.6 |

TABLE 8
Reactions with Variation of pH
Reactions with variation of pH

| | | | Ozone | |
|---|---|---|---|---|
| | Aniline | pH before | Exposure | Temperature |
| Reactions | (M) | reaction | (Seconds) | (° C.) |
| R-1 | 0.02 | 2 | 60 | 23 |
| R-2 | 0.02 | 4.03 | 60 | 23 |
| R-3 | 0.02 | 6.05 | 60 | 23 |
| R-4 | 0.02 | 8.15 | 60 | 23 |
| R-5 | 0.02 | 10.18 | 60 | 23 |
| R-6 | 0.02 | 12.04 | 60 | 23 |

### Results and Discussions

The oxidation of the aniline-water mixture with ozone is a complex reaction due to the formation of various radicals due to oxidation of water. Additionally, the rate of decomposition of ozone in water is dependent on various external factors including pH and temperature of water. The ozone decomposition rate increases with increase in pH and temperature of the reaction while at acidic pH and lower temperatures the ozone decomposition is slower.

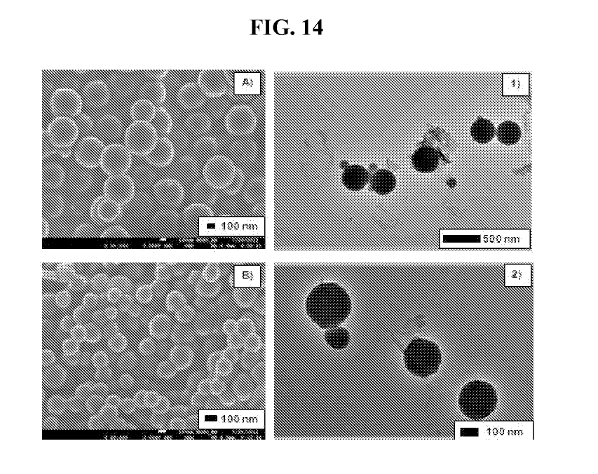

Dynamic light scattering experiments show that the particle size for the polyaniline nanospheres was in the range of 200-500 nm. These results complement the analysis of the polyaniline nanospheres via scanning and transmission electron microscopy (FIG. 14). When compared to the polypyrrole nanospheres, the size of the polyaniline nanospheres was larger. In order to analyze the reaction mechanism, pH of the reaction was measured at different time intervals of ozone exposure; it was observed that pH decreased as the reaction proceeds.

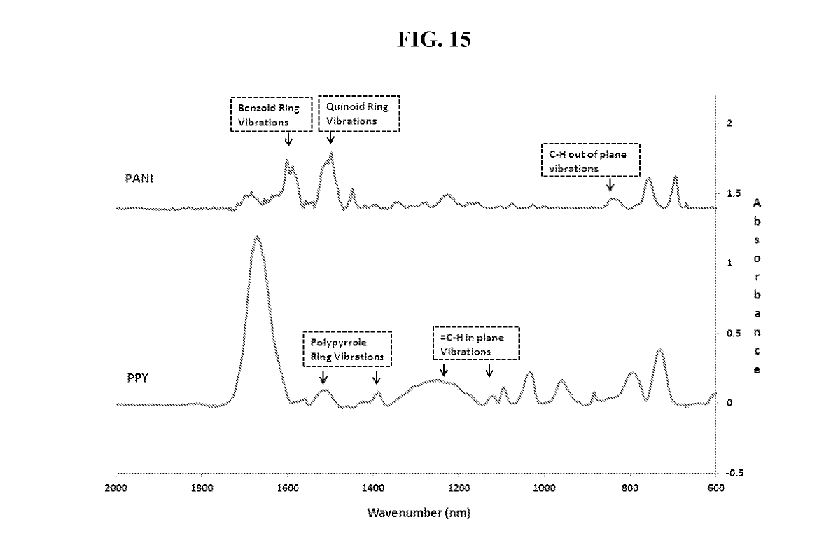

FIG. 15 shows FTIR spectroscopy of polyaniline (PANI) and polypyrrole (PPY) nanospheres. It was observed that PANI's characteristic quinonoid and benzenoid C═C stretching were present at 1587 cm⁻¹ and 1496 cm⁻¹ respectively. The absorption bands at 1211 cm⁻¹ and 1321 cm⁻¹ are assigned to —C—N and —C═N stretching modes with aromatic conjugation. The bands at 820 cm⁻¹ correspond to C—H out-of-plane vibrations. The bands for PPY at approximately 1489 cm⁻¹ and 1380 cm⁻¹ may be assigned to polypyrrole ring vibrations. The bands at 1220 cm⁻¹ and 1090 cm⁻¹ correspond to ═C—H in-plane vibrations and the bands at 774 cm⁻¹ and 881 cm⁻¹ correspond to out-of-plane vibrations indicating polymerization of pyrrole. The band at 1635 cm⁻¹ corresponds to a —C═O linkage.

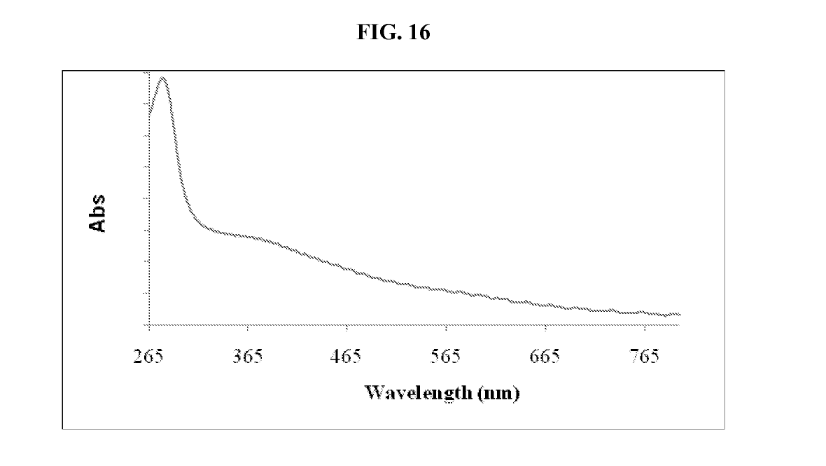

UV-VIS spectroscopy was also performed. (FIG. 16). An absorption peak at 380-400 nm was observed which corresponds to π-π* transition in PANI. Four point probe and conductive atomic force microscopy (C-AFM) measurements were performed on the nanospheres to measure conductivity and it was observed that the nanospheres were behaving like insulators, which may be due to interfacial resistance resulting from nano-spherical morphology. The non-conductive behavior of the nanospheres could also be due to the presence of overoxidized oligomers in the nanosphere shell.

### Example 3

### Synthesis of Polypyrrole Nanospheres

Polypyrrole nanospheres were synthesized according to the method of Example 1 using a monomer concentration of 0.17 M and an ozone exposure time of 60 seconds.

### Example 4

### Synthesis of Polyaniline Nanospheres

Polyaniline nanospheres were synthesized according to the method of Example 2 using a monomer concentration of 0.02 M and an ozone exposure time of 60 seconds.

### Example 5

### Synthesis of Polyaniline Nanobundles

Polyaniline nanobundles were synthesized by exposing 0.1 M aniline to ozone in 2 M HCl solution for 60 seconds followed by the addition of Hexahydrate ferric chloride at a concentration of 1 M to achieve a final concentration of 0.1 M of Hexahydrate ferric chloride. The reaction was aged for 4 days at 23 C before characterization.

### Example 6

### Preparation of a Conductive Polypyrrole Nanoparticle-Containing Coating

Polypyrrole nanoparticles have been dispersed into epoxy-amine coatings, at concentrations of 1-2 wt %, to determine if the nanoparticles impart novel properties to the coating. Differences were observed in the barrier properties as determine via Electrochemical Impedance Spectroscopy.

### Example 7

### Stabilized Silver Nanoparticle

Silver nitrate and pyrrole was obtained from Sigma Aldrich. Silver nitrate was used as received and pyrrole was distilled before use. 1 M and 0.5 M solution of silver nitrate and 0.1 M solution of pyrrole was prepared, in Millipore water, in separate flasks. ATLAS 30 C ozone generator, supplied by Absolute Ozone was used for obtaining ozone. Pure dried oxygen was supplied to the ozone generator at a pressure of 20 psi and flow rate of 0.2 L/min. According to the literature provided by Absolute Ozone this flow rate should produce oxygen/ozone mixture with 18% ozone by weight. Reactions were performed in a 125 ml Erlenmeyer flask at room temperature.

Ozone was bubbled through 100 ml of 0.1 M pyrrole (0.675 gram of pyrrole in 100 ml Millipore water) solution for 60 seconds under constant stirring. After the ozone exposure was complete excess ozone was removed by gently blowing a stream of air from compressed air line. Immediately after this 1 M or 0.5 M silver nitrate solution was added to the flask. The quantity of the silver nitrate solution was varied from 1 ml to 7.5 ml in various reactions. The reactions were kept under stirring for 24 Hours. The characterization of the sample was performed after 72 hours of the reactions. Table 7 lists the reactions performed with quantities of reactants used in each reaction.

TABLE 9
List of the reactions performed

| | | Ozone | | | Molarity of silver |
|---|---|---|---|---|---|
| | Pyrrole | exposure | Silver | | nitrate in final |
| | Solution | Duration | Nitrate | | reaction solution |
| Reaction | (100 ml) | (Seconds) | Solution | | (M) |
| R-1 | 0.1M | 60 | 1M | (7.5 ml) | 0.070 |
| R-2 | 0.1M | 60 | 1M | (6.37 ml) | 0.060 |
| R-3 | 0.1M | 60 | 1M | (4.25 ml) | 0.041 |
| R-4 | 0.1M | 60 | 1M | (2.12 ml) | 0.021 |
| R-5 | 0.1M | 60 | 0.5M | (3.00 ml) | 0.015 |
| R-6 | 0.1M | 60 | 1M | (1.00 ml) | 0.010 |

For example, for reaction R-1, ozone was bubbled for 60 seconds through 0.1 M, 100 ml Solution of Pyrrole in Millipore water at room temperature. Excess ozone was removed from the reaction after the completion of ozone exposure, using a gentle blow of air-stream from compressed air line. Immediately after this, 7.5 ml of 1 M silver nitrate solution was added to the flask. The reactions was performed under stirring at room temperature, the stirring was further continued for 24 hours.

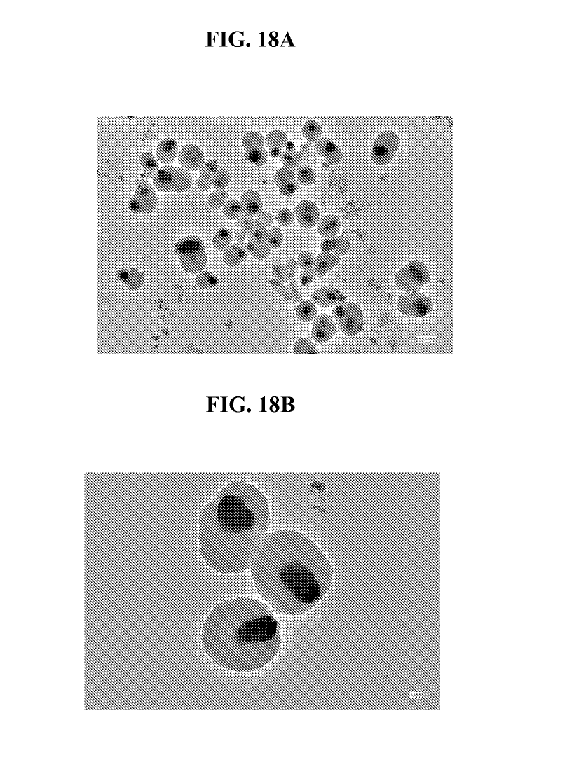

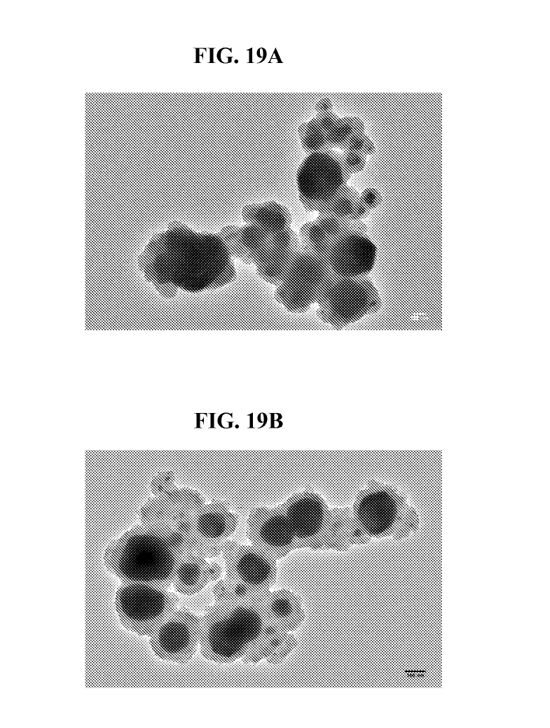

FIGS. 18A & 18B shows the TEM images for R-6 (core-shell morphology of silver polypyrrole can be observed) and FIGS. 19A & 19B shows TEM images for R-2 (nanocomposites of silver polypyrrole can be observed).

Various features and advantages of the invention are set forth in the following claims.

1. A template-free method of synthesizing conductive polymer nanoparticles comprising:
contacting a conductive monomer with an oxidant in an aqueous solvent to form conjugated polymer nanoparticles.

2. A template-free method of synthesizing conductive polymer nanoparticles consisting essentially of:
contacting a conductive monomer with an oxidant in an aqueous solvent.

3. A method of producing a stabilized nanoparticle comprising:
contacting a conductive monomer with an oxidant in an aqueous solvent to form a reaction mixture;
removing excess oxidant from the reaction mixture; and
adding a particle to the reaction mixture to form a stabilized nanoparticle;
wherein the stabilized nanoparticle has a coating of conductive polymer nanoparticles.

4. The method of claim 1 wherein the monomer is oligomerized prior to contacting the monomer with the oxidant.

5. The method of claim 1 wherein the monomer is selected from the group consisting of pyrrole, aniline, N,N-dimethylaniline, furan, pyridine, catechol, naphthalene, azulene, pyrene, 2,6-dimethylphenol, fluorine, carbazole, indole, 10-methoxy-5H-dibenzo-[B,F]-azepine, and diphenylacetylene.

6. The method of claim 5 wherein the monomer is pyrrole or aniline.

7. The method of claim 1 wherein the oxidant is selected from the group consisting of ozone, iron(III) chloride, copper(II) chloride, copper(II) sulfate, ammonium persulfate, silver nitrate, p-benzoquinone, potassium permanganate, and vanadium(V) oxide.

8. The method of claim 1 wherein the oxidant is ozone.

9. The method of claim 1 wherein the solvent comprises at least 10% water.

10. The method of claim 9 wherein the solvent further comprises a polar solvent.

11. The method of claim 10 wherein the polar solvent is an alcohol.

12. The method of claim 11 wherein the alcohol is ethanol.

13. The method of claim 1 wherein the monomer is present in an amount of from about 0.005 M to about 0.5 M.

14. The method of claim 1 wherein the monomer is contacted by the oxidant for no more than about 30 seconds.

15. The method of claim 1 wherein the monomer is contacted by the oxidant for no more than about 60 seconds.

16. The method of claim 1 wherein the monomer is contacted by the oxidant for no more than about 120 seconds.

17. The method of claim 1 wherein reaction occurs at a temperature of from about −15° C. to about 40° C.

18. The method of claim 1 wherein reaction occurs at a pH of about 2 to about 7.

19. The method of claim 1 wherein the conductive polymer nanoparticles have a mean diameter of from about 50 nanometers to about 500 nanometers.

20. The method of claim 3 wherein the particle is selected from the group consisting of silica, silver, gold and iron.

21. A stabilized conductive polymer nanoparticle wherein the nanoparticle is not stabilized sterically or electrostatically.

22. A conductive polymer nanoparticle with a zeta potential measurement of about zero.

23. A stabilized nanoparticle comprising a conductive polymer shell around the nanoparticle.

24. The stabilized nanoparticle of claim 23 wherein the particle is selected from the group consisting of silica, silver, gold and iron.

25. The stabilized nanoparticle of claim 23 wherein the conductive polymer shell is polypyrrole or polyaniline.

26. The method of claim 2 wherein the monomer is oligomerized prior to contacting the monomer with the oxidant.

27. The method of claim 2 wherein the monomer is selected from the group consisting of pyrrole, aniline, N,N-dimethylaniline, furan, pyridine, catechol, naphthalene, azulene, pyrene, 2,6-dimethylphenol, fluorine, carbazole, indole, 10-methoxy-5H-dibenzo-[B,F]-azepine, and diphenylacetylene.

28. The method of claim 27 wherein the monomer is pyrrole or aniline.

29. The method of claim 2 wherein the oxidant is selected from the group consisting of ozone, iron(III) chloride, copper(II) chloride, copper(II) sulfate, ammonium persulfate, silver nitrate, p-benzoquinone, potassium permanganate, and vanadium(V) oxide.

30. The method of claim 2 wherein the oxidant is ozone.

31. The method of claim 2 wherein the solvent comprises at least 10% water.

32. The method of claim 31 wherein the solvent further comprises a polar solvent.

33. The method of claim 32 wherein the polar solvent is an alcohol.

34. The method of claim 33 wherein the alcohol is ethanol.

35. The method of claim 2 wherein the monomer is present in an amount of from about 0.005 M to about 0.5 M.

36. The method of claim 2 wherein the monomer is contacted by the oxidant for no more than about 30 seconds.

37. The method of claim 2 wherein the monomer is contacted by the oxidant for no more than about 60 seconds.

38. The method of claim 2 wherein the monomer is contacted by the oxidant for no more than about 120 seconds.

39. The method of claim 2 wherein reaction occurs at a temperature of from about −15° C. to about 40° C.

40. The method of claim 2 wherein reaction occurs at a pH of about 2 to about 7.

41. The method of claim 2 wherein the conductive polymer nanoparticles have a mean diameter of from about 50 nanometers to about 500 nanometers.

42. The method of claim 3 wherein the monomer is oligomerized prior to contacting the monomer with the oxidant.

43. The method of claim 3 wherein the monomer is selected from the group consisting of pyrrole, aniline, N,N-dimethylaniline, furan, pyridine, catechol, naphthalene, azulene, pyrene, 2,6-dimethylphenol, fluorine, carbazole, indole, 10-methoxy-5H-dibenzo-[B,F]-azepine, and diphenylacetylene.

44. The method of claim 43 wherein the monomer is pyrrole or aniline.

45. The method of claim 3 wherein the oxidant is selected from the group consisting of ozone, iron(III) chloride, copper(II) chloride, copper(II) sulfate, ammonium persulfate, silver nitrate, p-benzoquinone, potassium permanganate, and vanadium(V) oxide.

46. The method of claim 3 wherein the oxidant is ozone.

47. The method of claim 3 wherein the solvent comprises at least 10% water.

48. The method of claim 47 wherein the solvent further comprises a polar solvent.

49. The method of claim 48 wherein the polar solvent is an alcohol.

50. The method of claim 49 wherein the alcohol is ethanol.

51. The method of claim 3 wherein the monomer is present in an amount of from about 0.005 M to about 0.5 M.

52. The method of claim 3 wherein the monomer is contacted by the oxidant for no more than about 30 seconds.

53. The method of claim 3 wherein the monomer is contacted by the oxidant for no more than about 60 seconds.

54. The method of claim 3 wherein the monomer is contacted by the oxidant for no more than about 120 seconds.

55. The method of claim 3 wherein reaction occurs at a temperature of from about −15° C. to about 40° C.

56. The method of claim 3 wherein reaction occurs at a pH of about 2 to about 7.

57. The method of claim 3 wherein the conductive polymer nanoparticles have a mean diameter of from about 50 nanometers to about 500 nanometers.
